(19) United States
(12) Patent Application Publication
(10) Pub. No.: US 2022/0414244 A1
(43) Pub. Date: Dec. 29, 2022

(54) SENDER-BASED CONSENT MECHANISM FOR SHARING IMAGES

(71) Applicant: International Business Machines Corporation, Armonk, NY (US)

(72) Inventors: Dharma Teja Atluri, Hyderabad (IN); Siddhartha Sood, Ghaziabad (IN); Santanu Ghosh, Kolkata (IN); Snehasish Ghosh, Kolkata (IN)

(21) Appl. No.: 17/304,580

(22) Filed: Jun. 23, 2021

(51) Int. Cl. G06F 21/62; G06F 16/176; G06T 1/00

(52) U.S. Cl. CPC G06F 21/6218; G06F 16/176; G06T 1/0021; G06T 2201/0065

(57) ABSTRACT

Control of sending content based on originating party consent is defined at the time content is sent or is pre-defined by the originating party. Metadata and originating party identifiers are attached to files to control sharing functionality at the operating system level and/or the application level. Only files consented to be sent may be shared by a receiving user. When consent is given to share a file, the receiver who subsequently shares the file becomes the controlling sender having authority to consent to further sharing of the file.

### BACKGROUND

The present invention relates generally to the field of file content sharing, and more particularly to sharing personal information based on owner consent.

It is known in the art to scan applications where a file is posted to social media or sent by messaging system to identify the sender or source of the file and/or posting.

Solutions are available commercially that track recipients of a file sent by electronic message or social media post, particularly after consent to forward the file is provided.

### SUMMARY

In one aspect of the present invention, a method, a computer program product, and a system includes: receiving a digital content file through an application running on a receiving device having an operating system; identifying a consent control feature in the digital content file; analyzing the consent control feature for a content sharing rule; responsive to the content sharing rule being “no forwarding,” calling the operating system of the receiving device; and causing the operating system to restrict sharing of the digital content file.

In another aspect of the present invention, a method, a computer program product, and a system includes: identifying digital content to be shared by a first user; attaching a consent control feature to the digital content; detecting receipt of the digital content by a second user, the digital content including the consent control feature; analyzing the consent control feature for a content sharing rule and consent owner; responsive to the content sharing rule being “sharing allowed,” updating the consent control feature of the digital content to indicate consent owner is the second user; and storing the digital content with an attached updated consent control feature in a managed content storage component.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system;

FIG. 4 is a flowchart showing a method performed, at least in part, by a second embodiment system; and

FIG. 5 is a schematic view of a machine logic portion of the second embodiment system according to the present invention.

### DETAILED DESCRIPTION

Control of sending content based on originating party consent is defined at the time content is sent or is pre-defined by the originating party. Metadata and originating party identifiers are attached to files to control sharing functionality at the operating system level and/or the application level. Only files consented to be sent may be shared by a receiving user. When consent is given to share a file, the receiver who subsequently shares the file becomes the controlling sender having authority to consent to further sharing of the file. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions, or acts, or carry out combinations of special purpose hardware and computer instructions.

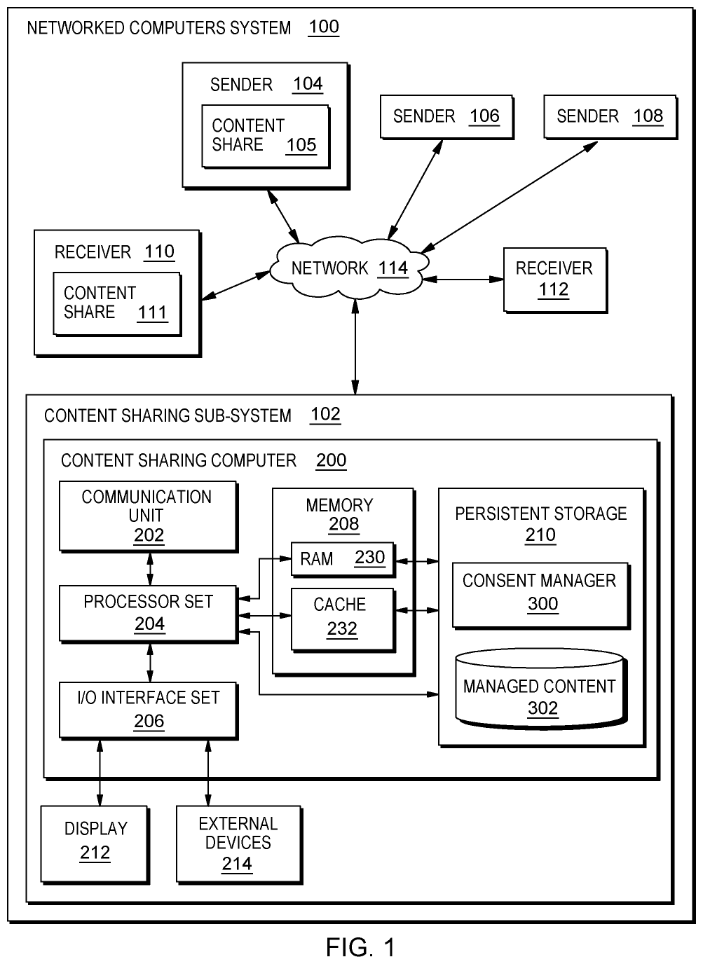

The present invention will now be described in detail with reference to the Figures. FIG. 1 is a functional block diagram illustrating various portions of networked computers system 100, in accordance with one embodiment of the present invention, including: content sharing sub-system 102; sender sub-systems 104, 106, 108; content share applications 105, 111; receiver sub-systems 110, 112; communication network 114; content sharing computer 200; communication unit 202; processor set 204; input/output (I/O) interface set 206; memory device 208; persistent storage device 210; display device 212; external device set 214; random access memory (RAM) devices 230; cache memory device 232; consent manager 300; and managed content store 302.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage, and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Consent manager 300 operates to control forwarding of content based on originating party consent defined by a content sharing rule established either at the time of sending or pre-defined by the originating party. Metadata and metadata identifiers are attached to files such as image files or multimedia files to control sharing functionality at the operating system level rather than the application level. Only files consented to be forwarded may be shared by a receiving user. When consent is given to share a file, the receiver who subsequently shares the file becomes the controlling sender having authority to consent to further sharing of the file.

Some embodiments of the present invention are directed to sender-imposed restrictions from forwarding image files at the image level. According to some embodiments, unique identifiers such as logos and watermarks are used within an application to restrict forwarding of images. Additionally, some embodiments of the present invention provide for an operating system to implement file control techniques external to individual applications by disabling print screen functionality based on metadata barcode information.

Some embodiments of the present invention recognize the following facts, potential problems and/or potential areas for improvement with respect to the current state of the art: (i) when a file is sent to intended recipients by a messaging application or chat service, there is no system-based enforcement to stop the receiver from further forwarding the file even if the sender does not provide consent; and/or (ii) current technology depends on the trust and/or the ethics of the receiver when handling the received file.

Users are able to share virtually any file from a smartphone by the click of a few buttons. Multimedia files such as images and videos are easily shared over a network using widely available messaging services across different platforms (software and devices). However, images circulated by social media posts and messaging applications are easily forwarded to third parties via the same or different messaging services without consent from the user who original circulated the multimedia file. Without a consent management system in place, concerns of rights and privileges arise such as: (i) loss of trust; (ii) loss of confidentiality; (iii) mishandling of personal identifying information; (iv) misuse of personal information; and/or (v) other unethical uses of private data.

Some embodiments of the present invention are directed to a method that will allow forwarding images and other multimedia files over chat services, messaging, and social media applications only if consent to forward is provided by the originating sender. The method uses a combination of chat services/applications and operating system functions to check whether consent is provided by using image detection algorithms.

According to some embodiments of the present invention, appropriate functions in the mobile device both internally and externally may be disabled to prevent images from being forwarded via chat services or social media posts when consent to forward is not provided by the originating sender.

Some embodiments of the present invention provide for consent to forward a file to be recognized by the operating system with reference to a watermark message embedded into the file.

Some embodiments of the present invention use metadata, a watermark mask (or a badge or padded lock icon or similar feature based on specific user interface implementation), an watermark image detection machine algorithm, and the native operating system functions to secure a file from being re-distributed without consent of the original sender.

Some embodiments of the present invention are implemented by a consent and rights management system (CRMS Module). The CRMS operates in conjunction with consent metadata of the image being forwarded to control further sharing of the image to third parties. According to some embodiments of the present invention, forwarding control is based on embedding multimedia files with a visible watermark in such a way as to not hinder the consumption of the content by a user. The CRMS module operates to ensure data security and privacy for files circulated by an originating sender.

Some embodiments of the present invention are directed to a unique metadata identifier or to metadata that is encrypted and added to the file information. The metadata is used to generate the visible water mark as mentioned above, which can be recognized by an image recognition machine learning algorithm.

According to some embodiments of the present invention, a service provider for a messaging application implements an added functionality so that the CRMS module can be integrated with a machine learning algorithm in the messaging application to interpret the watermark image and/or associated metadata and identify the user consent parameter as “YES” or “NO” to enable forwarding of the corresponding file. Alternatively, the consent parameter is “sharing allowed” or “no forwarding.” Regardless of the text associated with the consent parameter, there are selections, one indicating consent to share and another indicating no consent to share.

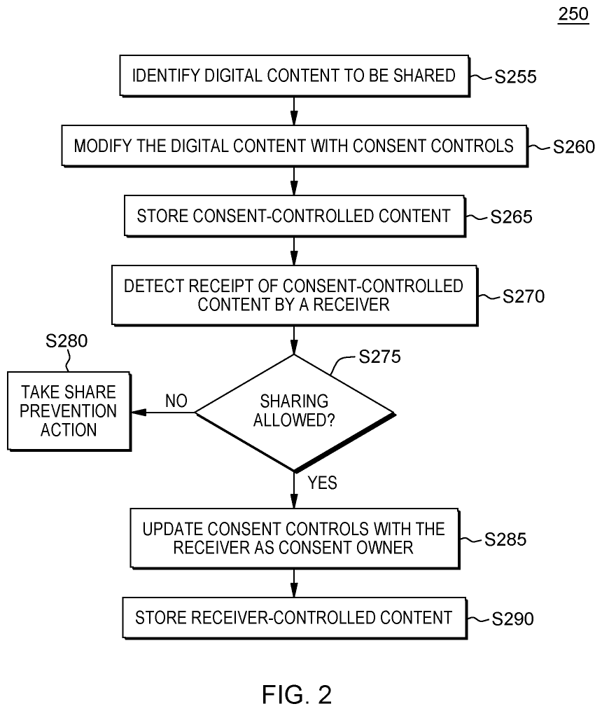

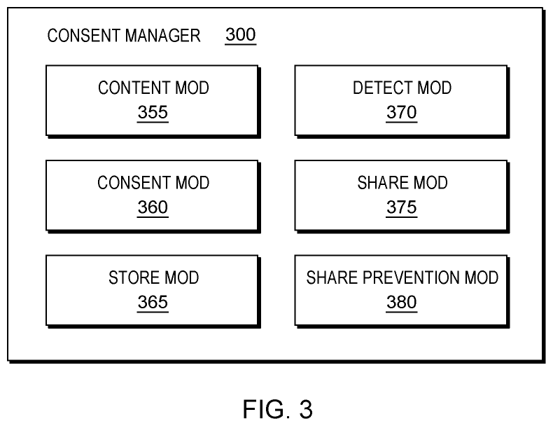

FIG. 2 shows flowchart 250 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins with step S255, where content module (“mod”) 355 identifies digital content to be shared. In this example, digital content is identified by user input indicating a piece of content will be shared. Alternatively, digital content is identified each time it is created or received by a user. Alternatively, digital content saved by particular software application, such as content share applications 105, 111 (FIG. 1), is identified upon a saving action as content to be shared or that might be shared. The term digital content as used herein refers to any file that may be transmitted digitally including image files and multimedia files.

Processing proceeds to step S260, where consent mod 360 modifies the digital content with consent controls. Consent controls may include digital metadata containing consent information, a unique metadata identifier, visible watermarks, and/or visible icons. The identified digital content may be modified to include one or more of the consent control features. Upon identification of the digital content, certain information is obtained for use as consent controls. For example, metadata containing consent information may include: (i) packet header details (name, size, format); (ii) sender details (name, contact info); (iii) source internet protocol (IP) address; (iv) consent flag (yes/no); (v) watermark unique identifier; and/or (vi) consent owner (sender/receiver). Unique metadata identifier may be a barcode mask or an internet link to consent information. Visible watermarks may be in a barcode format or an image containing information regarding consent status of the digital content. Finally, visible icons placed strategically on an image when shared may indicate by placement and/or by icon characteristics whether or not the associated image may be shared by a receiving party.

Processing proceeds to step S265, where store mod 365 stores consent-controlled content. When the digital content is modified to include consent controls in step S260, the digital content becomes consent-controlled content. In this example, consent-controlled content is stored in managed content store 302 (FIG. 1) for sharing according to the consent information. Consent-controlled content may be sender-controlled or receiver-controlled depending on the level of consent provided by the originating sender. Receiver-controlled content refers to a file that a sender granted consent for which the receiver, upon receipt, may restrict further sharing when sent by the receiver. Sender-controlled content refers to a file that the sender does not consent to sharing by receivers of the file.

Processing proceeds to step S270, where detect mod 370 detects receipt of consent-controlled content by a receiver. Stored digital content, including consent-controlled content, may be accessed by a software application for sharing. For example, sender 104 may access consent-controlled content from managed content store 302 via content share application 105 (FIG. 1). According to some embodiments of the present invention, the sender may only access consent-controlled content for which the sender is the consent owner. Upon receipt of consent-controlled content by a receiver, the receiving application or receiving operating system recognizes the file as being consent-controlled. For example, the metadata associated with the digital content indicates a consent-control mechanism exists for the content. According to some embodiments of the present invention, each sub-system of a networked computers system, such as networked computers system 100, includes software for recognizing consent-controlled digital content. In that way, when sender 104 sends consent-controlled content from managed content store 302 by content share application 105 to receiver 110, content share application 111 detects that consent-controlled content was received from the sender.

Processing proceeds to decision step S275, where share mod 375 determines whether or not sharing of the consent-controlled digital content is allowed. When the consent-controlled digital content is being prepared for sharing or being sent to another receiver, the share module operates to control sharing according to the consent metadata or consent watermark image. Determination of consent to share for consent-controlled digital content may require an image recognition machine learning algorithm to interpret a watermark image visible when viewing the digital content, such as a watermark on a picture. Alternatively, consent is determined according to consent metadata not visible when viewing the digital content. Consent metadata may be in the form of a barcode file or a table with consent information. If sharing is not allowed, processing follows the “NO” branch to step S280 where share prevention actions are taken. If sharing is allowed, processing follows the “YES” branch to step S285 for further processing of the digital content.

Following the “YES” branch to step S285, consent mod 360 updates consent controls of the digital content with the receiver as the consent owner creating receiver-controlled content. The receiver may consent or not consent to further sharing of the file. The updated consent controls may revise the consent owner from the identity of the sender to the identity of the receiver. The consent flag of the metadata or watermark image indicator may be revised from “yes” to “no” if the receiver does not want further forwarding to be permitted after being send by the receiver.

Processing ends at step S290, where store mod 365 stores the receiver-controlled content for later access and/or use. For example, the receiver-controlled content is stored in managed content store 302 (FIG. 1) for later access by receiver 110. Alternatively, users having access to the managed content store may view the receiver-controlled content but may only share the content according to consent given by the receiver. In that case, each user who accesses the managed content store operates as a “receiver” unless designated as the consent owner of a particular file.

Following the “NO” branch to step S280, share prevention mod 380 takes share prevention action. When the consent-controlled digital content being prepared for sharing or being sent to another receiver is determined to not have consent for sharing, various share prevention actions are available and may be taken according to various embodiments of the present invention. For example, when the receiver attempts to share the digital content by creating a screenshot, the operating system may disable screenshot capability to prevent potential sharing of the screenshot image. Alternatively, when a receiver attempts to share the digital content by sending it via an application, the application may disable the send functionality for the digital content. According to some embodiments of the present invention, when consent-controlled content is stored in the file system image buffer of the sub-system, the image recognition machine learning algorithm accesses the content and limits sharing according to the consent metadata or consent watermark image.

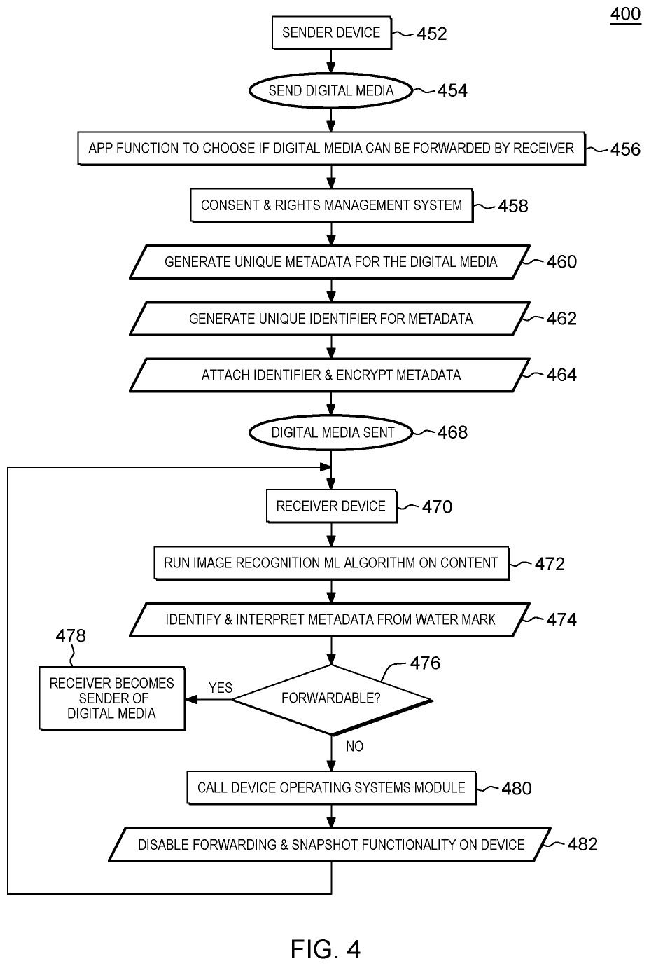

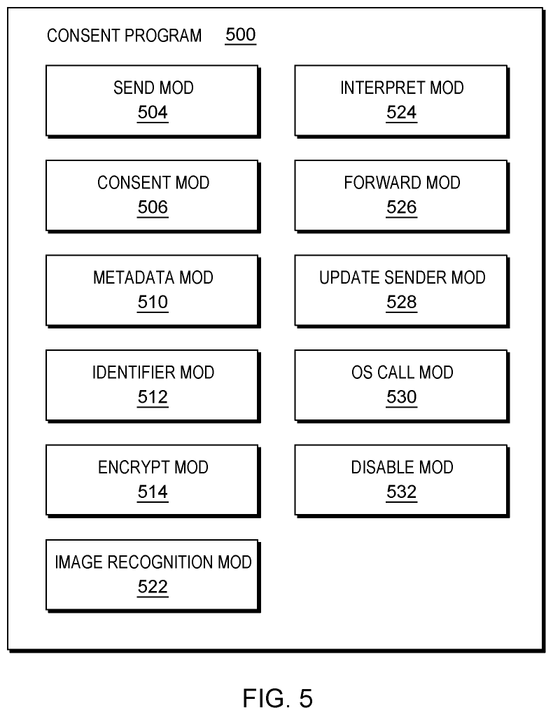

FIG. 4 shows flowchart 400 depicting a first method according to the present invention. FIG. 5 shows program 500 for performing at least some of the method steps of flowchart 400. This method and associated software will now be discussed, over the course of the following paragraphs, with extensive reference to FIG. 4 (for the method step blocks) and FIG. 5 (for the software blocks). Consent program 500 may be implemented in a networked computers system such as networked computers system 100 (FIG. 1).

Processing begins at step 454, where send module (“mod”) 504 sends from sender device 452 a digital media file. In the example going forward, the digital media file that is the subject of concern is an image file. Alternatively, a multimedia file or audio file is under consent control. As a user wants to share a new image or forward an image received from another user, the user attempts to send the image to a user.

Processing proceeds to step 456, where consent mod 506 initiates an application function to choose if the selected image can be forwarded be a receiving party. If the image is new or received by the user with consent to forward, the chat application or other application in which the images is being shared gives an option to select user consent while sending the image forward to other receivers.

Processing proceeds to step 460, where metadata mod 510 generates unique metadata for the image according to consent and rights management system (CRMS) 458. The forwarding application interacts with CRMS. The CRMS generates a unique metadata for the image being shared.

Processing proceeds to step 462, where metadata mod 510 further generates a unique identifier for the generated metadata. The unique watermark is generated on the basis of consent metadata generated in step 460.

Processing proceeds to step 464, where encrypt mod 522, attaches the identifier and encrypts the metadata. The metadata is embedded with the image information and the watermark is embedded in the image file. Some watermarks are visible to the receiver while some watermarks are only readable by the operating system for determining the consent level, or consent parameter, of the image file.

Processing proceeds to step 468, where send mod 504 sends the image file including the associated consent information and watermark image.

Processing proceeds to step 472, where image recognition mod 522 runs an image recognition machine learning algorithm on the image content upon receipt of the image file by the receiver to identify the watermark image and interpret the consent information therein or provided as other metadata. The pattern/image recognition functionality runs on the image(s) shared. According to some embodiments of the present invention, the watermark image is a barcode and the barcode is interpreted by the image recognition machine learning algorithm.

Processing proceeds to step 474, where interpret mod 524 identifies and interprets the metadata from the watermark image. The pattern/image recognition functionality identifies the pattern of the embedded watermark image. The pattern would suggest if the image file can be forwarded or not according to consent by the originating sender.

Processing proceeds to step 476, where forward mod 526 determines whether or not the image file can be forwarded based on the interpretation of the metadata. If the image metadata is interpreted that the image file can be shared with consent of the originating sender, processing follows the “YES” branch where update sender mod 528 updates the receiver to be the originating sender of the image. The term originating sender suggests who has authority to consent to further sharing of the image. Where consent is given when an image is shared, all receivers become senders for the purpose of future sharing activity. Processing ends at step 478 after following the “YES” branch from step 476.

If the message metadata is interpreted as the image cannot be forwarded, processing follows the “NO” branch to step 480.

Processing proceeds down the “NO” branch to step 480, where operating system call mod 530 call the device operating system to establish sharing restrictions for the image file.

Processing ends at step 482. where disable mod 532 disables forwarding and/or snapshot functionality on the receiver device with respect to the received image file. The message forwarding functionality on the chat service as well as the snapshot buttons on the device are disabled by the operating system. In the case of multiple images with some being allowed to be shared and some not being allowed to be shared, the images not being allowed to be shared, if being captured in a screenshot, would be obscured and cannot be made a copy of the source type. The watermark image will make it visible to the receiving user on why the obscuring action happened.

Further embodiments of the present invention are discussed in the paragraphs that follow.

Some embodiments of the present invention provide for any snapshot features on a user device to include the functionality to confirm forwarding of images as being enabled or disabled. In that way, if the multimedia file is being captured directly by an operating system function (such as print screen function) or indirectly by an application that sits on the operating system, the capture process would ultimately go to a file system image buffer such that the machine learning algorithm would have the capability to read the buffer and determine if the target image can be captured according to originating sender consent.

Some embodiments of the present invention are directed to special scenarios where multiple images are displayed on a display screen. When the content having the security watermark indicates no consent to forward, the particular image will be obscured when a screenshot is initiated such that the image can neither be consumed by the device where the content resides nor by an external device through which the user may take a screenshot. According to alternative embodiments, the user interface and operating system restrict taking and/or forwarding the screenshot when the image having no consent to forward is within the screenshot image.

According to some embodiments of the present invention, the operating system accesses the consent-related information and disables features such as forwarding of messages or taking screenshots according to pre-defined rules associated with certain consent parameters. That is, consent parameters may be more nuanced than mere “yes” and “no” consent. According to some embodiments of the present invention, consent may be yes for a particular messaging system, group of users, or other selected portion of potential user to whom the image may be sent by the receivers.

The present invention provides a control mechanism to increase data security and privacy and to eliminate misuse of information that would be implemented by either one or both message service providers and operating system (OS) vendors. The control mechanism will leverage a framework aligned to industry standard encoding methods, water marking technology, and the latest image recognition algorithms to give a one stop solution for securely sending/exchanging images from a variety of platforms.

According to some embodiments of the present invention, the consent and rights management system generates a consent or approval metadata including attributes such as sender and receiver details (including sender IMEI number), source IP address, consent flag value, watermark UID number, and consent owner information. This metadata will provide a unique identifier (UID) to the multimedia file to enforce the consent parameter of the consent owner. The originator of an image file will also be able to enforce consent decisions using operating system APIs and/or modules built into the chat service or social media application as functionality of the chat service. The value assigned to the consent flag drives the type of the barcode or other watermark image generated and strategically placed within the image to ensure it does not disturb viewing of the image but at the same time can be easily read by the software module which uses the image recognition machine learning algorithm. As mentioned, the watermark image generation is dynamic in nature (code based and unique for each piece of digital content) and follows a pattern for YES and NO options. The CRMS system will then water mark the digital content using the unique consent flag that is generated.

Some embodiments of the present invention are directed to an encryption and/or decryption module that leverages the existing Industry protocols (AES, DES, RSA) to encrypt the metadata when attached to the image information to securely identify the originating sender.

Some embodiments of the present invention are directed to a machine learning image detection algorithm involving an optical character recognition method or a specific image recognition algorithm to read the positioned watermark or other consent flag or symbol from the digital content. The image recognition model is trained on expected patterns of watermark images, flags, or symbols used to recognize and interpret the pattern accurately. According to some embodiments of the present invention, a supervised machine learning model is deployed for this purpose.

Some embodiments of the present invention are directed to an operating system integration module. Different devices may have different operating systems. The service provider of the chat service or messaging service works with the APIs provided by the operating system that would enable the operating system to interpret the information embedded in the image and take action to disable screenshot or forwarding functionality of the chat service with regard to the image bearing the watermark or other consent-identifying metadata. For example, if the image cannot be forwarded, the chat service will not only disable the forward option for the image but it will also enforce the operating system to disable screenshot functionality so that a screenshot cannot be taken of the displayed image for circulating as an originating sender.

According to some embodiments of the present invention, if the image is captured directly by an operating system function (example print screen) or indirectly by an application that sits on the operating system, the screen capture file would ultimately go to a file system image buffer and the same machine learning algorithm would have the capability to read the buffer and tell if the digital content should not be captured.

Some embodiments of the present invention are directed to controlling image copy and paste functionality with respect to originating sender consent. Alternatively, image forwarding functionality is controlled according to originating sender consent.

Some embodiments of the present invention are directed to a method to ensure control of forwarding of images using an embedded water mark or image generated based on the metadata associated with originating sender consent level.

Some embodiments of the present invention leverage image recognition or pattern identification to read and interpret embedded images and interpret metadata of images prior to allowing forwarding or copying/pasting actions.

According to some embodiments of the present invention, content metadata and watermark generation enables functionalities including taking screenshots and forwarding of images through the messaging services installed in the device. Messaging services include social media postings and chat systems among other services.

Some embodiments of the present invention are directed to selectively permitting operating system-based screenshots to be taken based on an image being captured and corresponding watermarks or metadata associated with the image.

Some embodiments of the present invention are directed to enforcing unintended sharing of images via a plurality of sharing services using a watermark mask and image detection algorithm.

Some embodiments of the present invention are directed to a process including the steps of identifying pattern within the images/audio/video files shared by a user to prevent forwarding to others without consent from an originating user to save privacy of the user; checking source of the image/audio/video from the other users for maintaining complete trace of initial originating device; generating a unique water mark or pattern for each image/audio/video files that extend to adding mobile and user-based metadata to extend use cases in future; building pattern recognition/image recognition with the identified pattern and extend it to customize as per type of source provider; and triggering alerts if hacking is performed on a target provider to further forward it without the consent of the originating user and not allowing auto save onto a receiver mobile device.

Some embodiments of the present invention do more than detecting a flood of unwanted messages in messaging applications (WhatsApp, Twitter) by capturing message data and applying a streaming machine learning algorithm to filter out sparse messages. Further, some embodiments of the present invention do more than automatically restrict further transmission of the message with a cluster of messages having a suspect pattern by generating alerts to senders/users to initiate corrective action. Further, some embodiments of the present invention do more than provide a watermark to user-created messages for assisting to trace ownership of the messages and to protect the user privacy data from sharing/forwarding the message.

Some embodiments of the present invention may include one, or more, of the following features, characteristics and/or advantages: (i) provides capability to the sender being able to control on who can receive the content and whether or not they can forward it further onto other recipients; (ii) provides metadata embedded into both visible and invisible watermarks which defines the controls put around if any plagiarism is attempted both by identifying the attempt and also putting in locks within the operating system of every possible application either in the system of receipt or when using a different system ensuring the content cannot be misused; (iii) leverages Image detection algorithm along with the text analysis pattern algorithms to ensure the recipient of the message cannot update/forward it without the consent provided by the sender; (iv) maintains the linkage to the sender at any given point in time to ensure the data security and privacy from an individual customer point of view are safeguarded; (v) doesn't need any restrictions by a dedicated app usage and can be integrated by any of the applications; (vi) no dependency on any external application to be specifically installed because not every image is consumed by only a dedicated application but the freedom of being able to use any device or application while maintaining security from third party sharing without consent; (vii) deployable on any platform and does not require users to have separate login authentication process apart from the pre-existing authentication used in the current system; (viii) allows for a hybrid approach by restricting only the images that the sender would like to restrict instead of the all content from the sender being locked out; and/or (ix) consistent adoption across devices and social digital media not having to differ the approach or where the consumption is made from during the usage by blacking out the content when an external device is used for replicating the content.

Some embodiments of the present invention are directed to consent propagation along with message which can be leveraged programmatically to enable/disable message copying, forwarding, or taking a screenshot thereby effectively disabling forwarding of certain images.

Some embodiments of the present invention are directed to the sending terminal having the complete control of how the receiving terminal, after receiving the image, can consume it and in which way with respect to type of control on the image the first terminal wants to have on the second terminal for that specific image.

Some embodiments of the present invention are directed to ensuring the second or the intended user does not share the image with a third party by only being able to forward it to upon consent of the originating sender.

Some embodiments of the present invention are directed to a conditional restriction to be applied by the person initiating the initial transfer ensuring other than those intended cannot forward it others to whom the initial person does not want to share the content with.

Some embodiments of the present invention are directed to how a sender can control the option of whether or not the receiver can actually forward a received image downstream without the sender permitting it.

Some embodiments of the present invention are directed to data security and privacy of a sender when about to share an image with another party.

Some embodiments of the present invention are directed to watermark enablement as underlying metadata to protect the originality of the content being shared.

Some embodiments of the present invention are directed to stopping a receiver of an image from sharing the image without the consent from the originating sender.

Some embodiments of the present invention are directed to an image detection algorithm or text analysis with respect to privacy setting analysis for certain shared images.

Some embodiments of the present invention are directed to controlling sharing at an individual image level based on consent level of an originating sharing party.

Some embodiments of the present invention are directed to integrating the application of consent control of image sharing across any software not having to restrict it to a particular application.

Some embodiments of the present invention are directed to watermark placement by AI/ML technique to avoid manual changes or modification.

Some embodiments of the present invention are directed to content control when mixed strategies are applied with multiple images instead of blocking everything from display in a screenshot.

Some embodiments of the present invention are directed to a mechanism to safeguard the unwanted posting of content onto social media without the consent from the initial sender. Even when a sender posts an image on social media, the same restrictions apply as when on mobile to contain unwanted consumption as with the watermark enabled if anyone else other than the intended recipient tries to consume the image would be blurred out ensuring no one else can use external devices to make copies of the image if not approved.

Some embodiments of the present invention are directed to forward consent by use of embedded watermarks where the watermark embedding process is automatic and both the placement and detection of the watermark is performed by leveraging artificial intelligence and machine learning techniques such as image detection and text pattern analysis.

Some embodiments of the present invention are directed to a system and method to provide the capability to the sender to be in control on who can receive shared images and whether or not a receiving party can forward the images to third parties, thus safeguarding the privacy of the sharing user.

Some embodiments of the present invention are directed to a system and method for an machine learning driven solution and method that can both embed visible watermarks and non-visible watermarks (metadata) into an image to lock down the operating system and other forwarding capabilities when consent is not provided for sharing the image by the originating sharer.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
receiving a digital content file through an application running on a receiving device having an operating system;
identifying a consent control feature in the digital content file;
analyzing the consent control feature for a content sharing rule;
responsive to the content sharing rule being “no forwarding,” calling the operating system of the receiving device;
causing the operating system to restrict sharing of the digital content file.

2. The computer-implemented method of claim 1, wherein restricting sharing includes:
disabling the forwarding functionality of the application for the received image file.

3. The computer-implemented method of claim 1, wherein restricting sharing includes:
disabling the screenshot functionality on the receiving device with respect to the received image.

4. The computer-implemented method of claim 1, further comprising:
analyzing the consent control feature with an image recognition algorithm; and
wherein:
the consent control feature is a watermark image.

5. The computer-implemented method of claim 1, wherein the consent control feature is a metadata record attached to the digital content file.

6. The computer-implemented method of claim 1, further comprising:
analyzing the consent control feature for consent information including: a consent flag, consent owner, and sender information.

7. A computer-implemented method comprising:
identifying digital content to be shared by a first user;
attaching a consent control feature to the digital content;
detecting receipt of the digital content by a second user, the digital content including the consent control feature;
analyzing the consent control feature for a content sharing rule and consent owner;
responsive to the content sharing rule being “sharing allowed,” updating the consent control feature of the digital content to indicate consent owner is the second user;
storing the digital content with an attached updated consent control feature in a managed content storage component.

8. The computer-implemented method of claim 7, further comprising:
analyzing the consent control feature with an image recognition algorithm; and
wherein:
the consent control feature is a watermark image.

9. The computer-implemented method of claim 7, attaching a consent control feature to the digital content includes:
generating a metadata record including a consent parameter and a consent owner;
generating a barcode image for the metadata record; and
attaching the barcode image to the digital content.

10. The computer-implemented method of claim 7, further comprising:
determining a consent parameter for the digital content; and
wherein:
the consent control feature indicates the consent parameter.

11. The computer-implemented method of claim 7, further comprising:
storing the digital content with the attached consent control feature, the consent owner being the first user; and
sending the digital content from the first user based on the consent owner being the first user; and
receiving the digital content by the second user.

12. A computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to perform a method comprising:
receiving a digital content file through an application running on a receiving device having an operating system;
identifying a consent control feature in the digital content file;
analyzing the consent control feature for a content sharing rule;
responsive to the content sharing rule being “no forwarding,” calling the operating system of the receiving device;
causing the operating system to restrict sharing of the digital content file.

13. The computer system of claim 12, wherein restricting sharing includes:
disabling the forwarding functionality of the application for the received image file.

14. The computer system of claim 12, wherein restricting sharing includes:
disabling the screenshot functionality on the receiving device with respect to the received image.

15. The computer system of claim 12, further causing the processor set to perform a method comprising:
analyzing the consent control feature with an image recognition algorithm; and
wherein:
the consent control feature is a watermark image.

16. The computer system of claim 12, wherein the consent control feature is a metadata record attached to the digital content file.

17. The computer system of claim 12, further causing the processor set to perform a method comprising:
analyzing the consent control feature for consent information including: a consent flag, consent owner, and sender information.
